(19) United States
(12) Patent Application Publication
(10) Pub. No.: US 2009/0052181 A1
(43) Pub. Date: Feb. 26, 2009

(54) WORKING LAMP

(76) Inventor: Jincan Mao, Yuyao City (CN)

Correspondence Address: CONNOLLY BOVE LODGE & HUTZ, LLP, P O BOX 2207, WILMINGTON, DE, 19899, US

(21) Appl. No.: 12/185,858

(22) Filed: Aug. 5, 2008

(30) Foreign Application Priority Data
Aug. 20, 2007 (CN) 200720174720.5

(51) Int. Cl. F21L 14/00

(52) U.S. Cl. 362/257

(57) ABSTRACT

A working lamp is provided, comprising a lamp head, a lamp body, and a luminous body array disposed on one side of the lamp body. Additionally, the working lamp further comprises a detachable bracket and a connecting part located on the other side of the lamp body. Moreover, the working lamp further comprises a charging base matching with the lamp body so as to charge the chargeable battery in the lamp body without electrical contact. While in use, the detachable bracket can be applied if necessary, eliminating the need for hand holding. Besides, the connection will be more stable as a screw hole is provided on the magnet, and being dustproof and waterproof as well as charging without electrical contact are achieved due to sealed measures.

### STATEMENT OF RELATED APPLICATION

The present application claims priority of the Chinese Patent Application No. 200720174720.5, entitled “Working Lamp”, filed on Aug. 20, 2007, which is incorporated herein by reference in its entirety.

### FIELD OF THE INVENTION

The present invention relates to a working lamp, specifically to a working lamp with a detachable bracket which is suitable for use in the field.

### BACKGROUND OF THE INVENTION

In order to satisfy various demand for illumination in the daily life, people have invented many kinds of illuminators. The US patent No. 2006/0034078A1 provides a chargeable LED working lamp, as shown in FIG. 1. This working lamp can be disposed on a charging base such that the battery inside the lamp body is charged, and comprises a LED array arranged in columns and rows for illumination. The LED array is connected to the battery in groups via a switch having at least two “ON” positions. The chargeable LED working lamp comprises at least one hook member and a pair of handle cushions, in which the hook member can be stored in the recess on the back of the housing.

It can be seen that the chargeable LED working lamp disclosed in the patent documentation US 2006/0034078A1 must be held by a user when in use, which causes inconvenience in some situations. Moreover, this working lamp is not waterproof and can not be charged without electrical contact.

### SUMMARY OF THE INVENTION

The object of the present invention is to overcome the above-mentioned shortcomings presented in the present working lamp and provide a waterproof working lamp with a detachable bracket which can be charged without electrical contact. In order to achieve this object, the present invention adopts following technical solutions.

According to the first aspect of embodiments of the present invention, there is provided a working lamp, comprising: a lamp body provided with a luminous body array on one side of the lamp body; and a detachable bracket; wherein a connecting part located on the other side of the lamp body opposite to the luminous body array and the lamp body is connected with the detachable bracket via the connection part; wherein the luminous body is LED.

Optionally, the connecting part is a screw hole and the detachable bracket is connected with the lamp body via a screw.

Still optionally, the connecting part is a magnet and another magnet is correspondingly provided on the detachable bracket, which has a reverse polarity with respect to the one on the lamp body. Preferably, a screw hole is provided on the magnet as the connecting part on the lamp body and the detachable bracket is connected with the lamp body via the magnets and the screw.

Further optionally, the connecting part is a slot and a grab is correspondingly provided on the detachable bracket. Alternatively, the connecting part is a grab and a slot is correspondingly provided on the detachable bracket.

Preferably, a connecting part on the detachable bracket used to connect with the lamp body is rotatable with respect to the other parts of the detachable bracket.

Still preferably, the working lamp according to the first aspect of the embodiment of the present invention further comprises a charging base matching with the lamp body; wherein the housing of the lamp body is sealed with no exposed electrode; a primary charging coil is provided in the charging base and a secondary charging coil in the lamp body so as to charge a chargeable battery in the lamp body without electrical contact.

According to the second aspect of embodiments of the present invention, there is provided a working lamp, comprising: a lamp head, a lamp body, and a luminous body array disposed on one side of the lamp body; wherein the luminous body is LED.

The working lamp according to the second aspect of embodiments of the present invention further comprises a detachable bracket and a connecting part located on the other side of the lamp body opposite to the luminous body array, wherein the lamp body is connected with the detachable bracket via the connection part.

Optionally, the connecting part on the lamp body is a screw hole, and the detachable bracket is connected with the lamp body via a screw.

Still optionally, the connecting part is a magnet, and another magnet, which has a reverse polarity with respect to the one on the lamp body, is disposed on the detachable bracket. Preferably, a screw hole is provided on the magnet as the connecting part on the lamp body and the detachable bracket is connected with the lamp body via the magnets and a screw.

Further optionally, the connecting part is a slot and a grab is correspondingly arranged on the detachable bracket. Alternatively, the connecting part is a grab and a slot is correspondingly arranged on the detachable bracket.

Preferably, a connecting part on the detachable bracket used to connect with the lamp body is rotatable with respect to the other parts of the detachable bracket.

Still preferably, the working lamp according to the second aspect of embodiments of the present invention further comprises a charging base matching with the lamp body, wherein the housing of the lamp body is sealed with no exposed electrode, and a primary charging coil is provided in the charging base and a secondary charging coil in the lamp body such that a chargeable battery in the lamp body is charged without electrical contact.

Compared with the existing illuminators, the working lamp according to the embodiment of the present invention embodies the beneficial effects in the following aspects:

1. When in use, it can be supported by the detachable bracket if necessary, eliminating the need for hand holding;

2. Apart from the side capable of illuminating, the directionality of the side illumination and the head illumination can be changed as well;

3. The connection between the lamp body and the detachable bracket is convenient and becomes more stable as a screw hole is disposed on the magnet;

4. Sealed measures ensure dustproof and waterproof;

5. The working lamp can be charged without electrical contact.

### BRIEF DESCRIPTION OF THE DRAWINGS

The present invention will be described further in combination with the drawings below.

FIG. 1 is a schematic diagram of a chargeable LED working lamp in the prior art;

FIG. 2 is a schematic diagram of the working lamp and the charging base according to the embodiment of the present invention;

FIG. 3 is a schematic diagram of the working lamp and the detachable bracket according to the embodiment of the present invention;

FIG. 4 is a schematic diagram of the detachable bracket for the working lamp according to the embodiment of the present invention;

FIG. 5 is a schematic diagram of the detachable bracket for the working lamp according to another embodiment of the present invention;

FIG. 6 is a schematic diagram of the working lamp and detachable bracket according to another embodiment of the present invention;

FIG. 7 is a schematic diagram of the detachable bracket for the working lamp according to still another embodiment of the present invention;

FIG. 8 is a local cut-away view of the working lamp and the charging base according to the embodiment of the present invention;

FIG. 9 is a schematic diagram of the secondary charging coil in the working lamp coupling with the primary charging coil in the charging base according to the embodiment of the present invention;

FIG. 10 is a schematic diagram of working state of the working lamp according to the embodiment of the present invention.

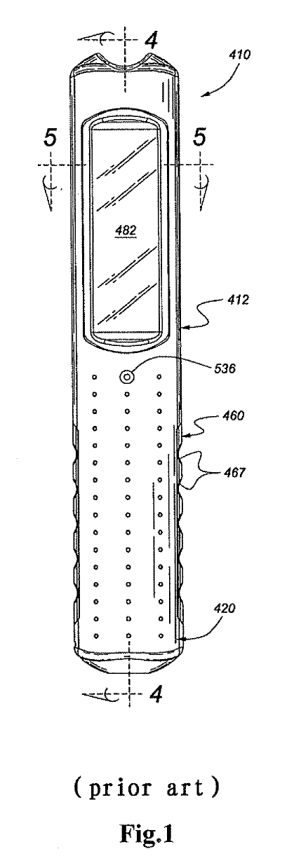

### DETAILED DESCRIPTION OF THE INVENTION

### EXAMPLE 1

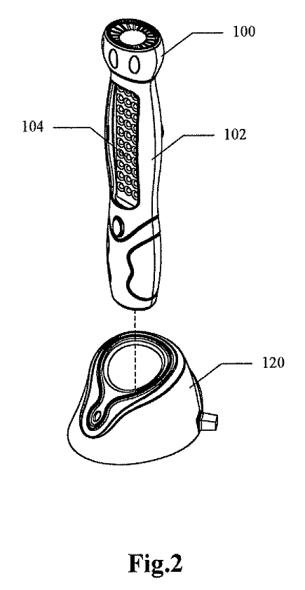

As shown in FIG. 2, a working lamp according to the present embodiment comprises a lamp head 100 and a lamp body 102, wherein a luminous body array 104 covered by a transparent cover is arranged on one side of the lamp body, which preferably is LED arranged in columns and rows.

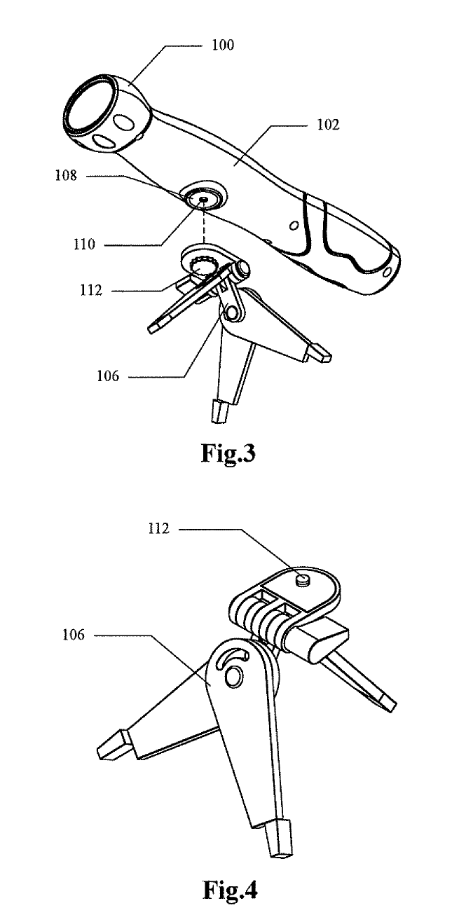

As shown in FIG. 3, the working lamp according to the present embodiment further comprises a detachable bracket 106 and a connecting part 108 located on the other side of the lamp body 102 opposite to the luminous body array 104, wherein the lamp body 102 is connected with the detachable bracket 106 via the connection part 108.

As shown in FIGS. 3 and 4, in the present embodiment, the connecting part 108 on the lamp body 102 is a screw hole 110, and the detachable bracket 106 is connected with the lamp body 102 via a screw 112.

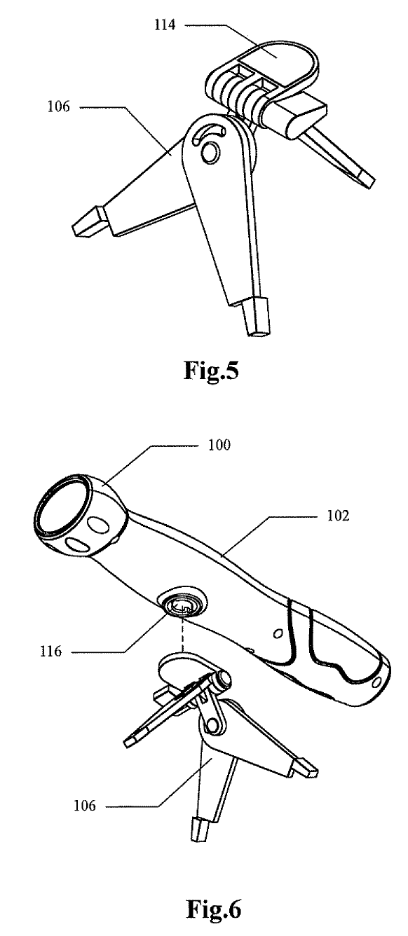

In another embodiment, the connecting part 108 can also be a magnet, and another magnet 114 is disposed on the detachable bracket 106, which has a reverse polarity with respect to the one on the lamp body 102, as shown in FIG. 5, and the detachable bracket 106 is connected with the lamp body 102 via the magnets with reverse polarities. Preferably, a screw hole 110 is disposed on the magnet as the connecting part on the lamp body 102, and the screw 112 connects the detachable bracket 106 with the lamp body 102.

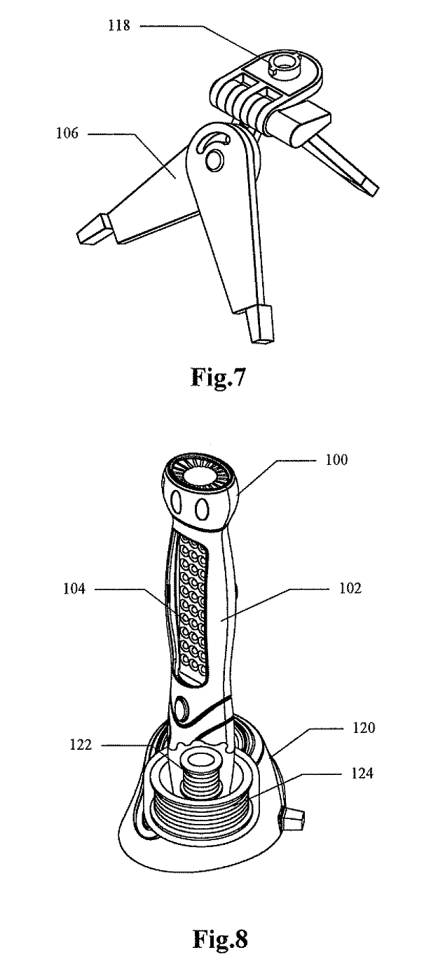

As shown in FIGS. 6 and 7, in another embodiment, the connecting part on the lamp body 102 can also be a slot 116, and a grab 118 is correspondingly provided on the detachable bracket 106, thereby the detachable bracket 106 is connected with the lamp body 102 via the slot 116 and the grab 118. Alternatively, the grab 118 can be provided on the lamp body 102 and the slot 118 correspondingly on the detachable bracket 106.

According to the embodiment of the present invention, the connecting part in the detachable bracket 106 used to connect with the lamp body 102 is rotatable with respect to the other parts of the detachable bracket, thus changing the directionality of the side illumination and the head illumination of the working lamp.

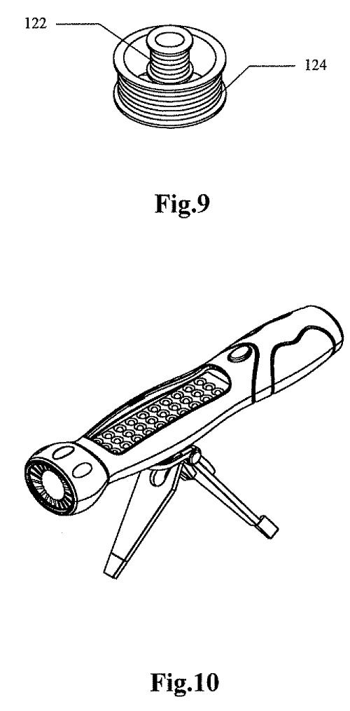

As shown in FIGS. 8 and 9, the working lamp according to the embodiment of the present invention further comprises: a charging base 120 matching with the lamp body 102, the housing of the lamp body 102 is sealed with no exposed electrode. A primary charging coil 124 is provided in the charging base 120 and a secondary charging coil 122 in the lamp body 102 such that the chargeable battery in the lamp body is charged without electrical contact by coupling the primary charging coil 124 with the secondary charging coil 122. Considering that the remaining parts of the charging circuit belong to the prior art, it will not be described in detail herein. Based on the teaching of the present embodiments, a person skilled in the art can understand completely how to realize charging of the chargeable battery inside the working lamp via a specific circuit.

As shown in FIG. 10, the working lamp can be mounted on the detachable bracket when in use and the illuminating direction of the working lamp can be adjusted if necessary.

### EXAMPLE 2

The working lamp according to the present embodiment is substantially the same as that of example 1 except that there is not provided with a lamp head. Except for the lamp head, the remaining components of the working lamps in example 1 and 2 are the same, so the working lamp according to the present embodiment is not described in detail herein.

### PARTS LIST

100 a lamp head

102 a lamp body

104 a luminous body array

106 a detachable bracket

108 a connecting part

110 a screw hole

112 a screw

114 a magnet

116 a slot

118 a grab

120 a charging base

122 a secondary charging coil

124 a primary charging coil

1. A working lamp, comprising:
a lamp body provided with a luminous body array on one side of the lamp body; and
a detachable bracket;
wherein a connecting part located on the other side of the lamp body opposite to the luminous body array and the lamp body is connected with the detachable bracket via the connection part.

2. The working lamp according to claim 1, wherein the connecting part is a screw hole and the detachable bracket is connected with the lamp body via a screw.

3. The working lamp according to claim 1, wherein the connecting part is a magnet and another magnet is correspondingly provided on the detachable bracket, which has a reverse polarity with respect to the one on the lamp body.

4. The working lamp according to claim 3, wherein a screw hole is provided on the magnet as the connecting part on the lamp body and the detachable bracket is connected with the lamp body via the magnets and the screw.

5. The working lamp according to claim 1, wherein the connecting part is a slot and a grab is correspondingly provided on the detachable bracket.

6. The working lamp according to claim 1, wherein the connecting part is a grab and a slot is correspondingly provided on the detachable bracket.

7. The working lamp according to claim 1, wherein a connecting part on the detachable bracket used to connect with the lamp body is rotatable with respect to the other parts of the detachable bracket.

8. The working lamp according to claim 1, further comprising:
a charging base matching with the lamp body;
wherein the housing of the lamp body is sealed with no exposed electrode; a primary charging coil is provided in the charging base and a secondary charging coil in the lamp body so as to charge a chargeable battery in the lamp body without electrical contact.

9. The working lamp according to claim 1, wherein the luminous body is LED.

10. A working lamp, comprising:
a lamp head;
a lamp body; and
a luminous body array disposed on one side of the lamp body.

11. The working lamp according to claim 10, further comprising:
a detachable bracket; and
a connecting part located on the other side of the lamp body opposite to the luminous body array;
wherein the lamp body is connected with the detachable bracket via the connection part.

12. The working lamp according to claim 11, wherein the connecting part is a screw hole and the detachable bracket is connected with the lamp body via a screw.

13. The working lamp according to claim 11, wherein the connecting part is a magnet and another magnet is correspondingly provided on the detachable bracket, which has a reverse polarity with respect to the one on the lamp body.

14. The working lamp according to claim 13, wherein a screw hole is provided on the magnet as the connecting part on the lamp body and the detachable bracket is connected with the lamp body via the magnets and the screw.

15. The working lamp according to claim 11, wherein the connecting part is a slot and a grab is correspondingly provided on the detachable bracket.

16. The working lamp according to claim 11, wherein the connecting part is a grab and a slot is correspondingly provided on the detachable bracket.

17. The working lamp according to claim 11, wherein a connecting part on the detachable bracket used to connect with the lamp body is rotatable with respect to the other parts of the detachable bracket.

18. The working lamp according to claim 10, further comprising:
a charging base matching with the lamp body;
wherein the housing of the lamp body is sealed with no exposed electrode; a primary charging coil is provided in the charging base and a secondary charging coil in the lamp body so as to charge a chargeable battery in the lamp body without electrical contact.

19. The working lamp according to claim 10, wherein the luminous body is LED.
